(19) United States
(12) Patent Application Publication
(10) Pub. No.: US 2007/0216768 A1
(43) Pub. Date: Sep. 20, 2007

(54) DEVICE AND METHOD FOR OUTWARDLY LOOKING IR CAMERA MOUNTED INSIDE VEHICLES PARTICULARLY SUITED FOR PRE-CRASH SENSING AND PEDESTRIAN DETECTION

(75) Inventors: Gregory Smith, Ann Arbor, MI (US); Nicholas Zorka, Clarkston, MI (US); Kwaku Prakah-Asante, Commerce Twp., MI (US); Samuel E. Ebenstein, Southfield, MI (US); Patrick Canfield, Dearborn, MI (US); Yelena Rodin, Southfield, MI (US)

Correspondence Address: Dickinson Wright PLLC, 38525 Woodward Avenue, Suite 2000, Bloomfield Hills, MI, 48304, US

(73) Assignee: FORD GLOBAL TECHNOLOGIES, LLC, Dearborn, MI (US)

(21) Appl. No.: 11/308,248

(22) Filed: Mar. 14, 2006

(51) Int. Cl. H04N 7/18

(52) U.S. Cl. 348/118

(57) ABSTRACT

A system for mounting a camera 46 within a vehicle is illustrated. The camera 46 may be positioned behind an IR transmissible window 82 within the vehicle and within a housing 36 within the vehicle. The camera 46 is thus placed between the windshield 20 and the housing 36 so that the field of view 60 of the camera is through the window 82. A notch shape 78 or hole 26 may be formed within the windshield so that the IR transmissive portion may be inserted therein.

### TECHNICAL FIELD

The present invention relates generally to both night vision and pedestrian detection systems for automotive vehicles, and more particularly, to a method for mounting a camera within a vehicle relative to a transmissive insert installed in portion at the windshield.

### BACKGROUND

Both far infrared and visible cameras are finding more applications in automotive vehicles. Far infrared cameras may be used for night vision applications, detecting pedestrians and other pre-crash sensing applications. Visible light applications (which are also usually sensitive to near infrared wavelengths) may be used for adaptive cruise control in various other pre-crash sensing applications. In some applications, the cameras are mounted on the exterior of the vehicle. Because the cameras are mounted on the exterior of the vehicle, they must withstand weather and other extreme conditions like salt spray and road debris. Hardening the camera to withstand these harsh conditions can double the costs of a unit. It is therefore desirable to mount the cameras within the vehicle.

One problem with mounting a camera within a vehicle is that the light transmission characteristics of the automotive windshield limit the performance of visible light cameras and preclude the use of near and far infrared cameras. Glass is opaque at the 7.5 to 13.5 nm wavelengths employed by far infrared sensors and standard automotive windshields filter out most of the light in the near infrared wavelengths from 680 to 1200 um. They are tinted and contain material to absorb near infrared from the sun to reduce the heat load on the vehicle interior. Windshields block up to 90 percent of near infrared light and 30 percent of visible light. This reduces the efficiency of visible light cameras during both day and night operation.

Another problem with exterior mounted cameras is that because of the contamination, it is difficult and expensive to keep them clean. Because these cameras are typically mounted in the grill, the field of view is also much less desirable near the vehicle. Therefore, it would be desirable to mount the cameras within the vehicle passenger compartment to prevent exposure to harsh environments if it were possible to overcome the infrared transmissibility problem of windshields.

### SUMMARY

The present invention uses an infrared transmissive insert disposed in a hole or notch within the windshield. This allows infrared light to be received by a camera.

In one aspect of the invention, a windshield having a generally rectangular shape has a top side, bottom side, right side, and left side. The top side has a notch shape formed therein. An insert having one or more IR transmissive portions is coupled to the top side within said notch so that the top side with the insert forms a continuous side.

In a further aspect of the invention, a windshield may be provided with one or more holes therein. An IR transmissive window may be disposed within these holes. A grommet may be disposed between the transmissive window and the windshield.

In a further aspect of the invention, a windshield may be provided with a hole. An insert transparent to near IR may be disposed within this hole. Further, a hole may be provided in the near IR transparent insert into which may be disposed a window transparent to far IR. In this manner a visible/near IR camera could acquire scenes through the hear IR insert while a far IR camera could acquire scenes through the far IR window disposed in the insert.

In all cases, a housing originally mounted to the roof structure of the vehicle will be used to house a camera. The housing will be made of durable material so that the windshield and housing meet regulated breakage requirements. That is, should breakage occur in the insert or the IR transmissive window, the housing would protect the vehicle occupants.

One advantage of the invention is that the camera may be disposed at a higher and further back location which improves the field of view of the camera.

Another advantage of the invention is that by sealing the camera within the housing in the passenger compartment, the plasticizers and adhesive emissions typically generated from new vehicle interiors is prevented from being deposited on the camera.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1A is a top view of an automotive vehicle having a sensor mounted in the grill.

FIG. 1B is a top view of an automotive vehicle having the sensor mounted within the vehicle according to the present invention.

FIG. 2 is a front view of a windshield having a hole therein with an IR transmissive insert therein.

FIG. 3 is a cross-sectional view of the system of FIG. 2.

FIG. 4A is a front view of an automotive vehicle with a windshield having a notch according to a second embodiment of the present invention.

FIG. 4B is a front view of a windshield having two IR transmissive positions.

FIG. 5 is a cross-sectional view of the embodiment of FIG. 4.

FIG. 6 is a cross-sectional view of a portion of a windshield and an IR transmissive window area formed according to the present invention.

FIG. 7 is a cross-sectional view of an alternative method for coupling the IR transmissive area with the windshield.

### DETAILED DESCRIPTION OF THE PREFERRED EMBODIMENT

In the following figures the same reference numerals will be used to identify the same components.

The present invention is directed to a camera-based system such as pedestrian detection system, a pre-crash sensing system, an active cruise control system, or the like. Those skilled in the art will recognize various other applications may use the configurations set forth above. It should also be noted that the cameras of the present invention may be used for various other applications such as rain sensing for rain sensing windshield wipers, headlight dipping for oncoming vehicles, or the like.

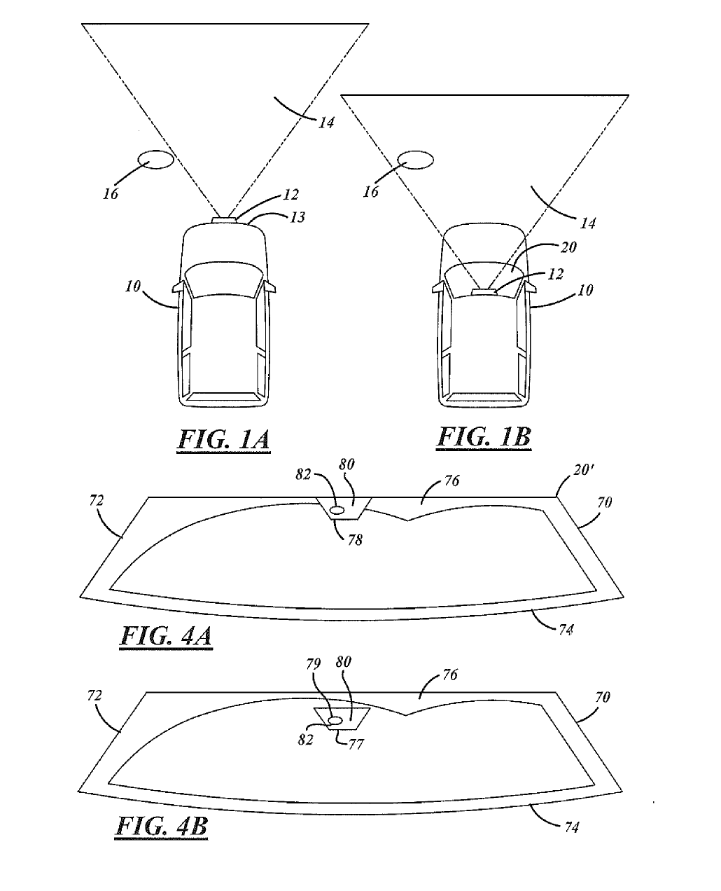

Referring now to FIG. 1A, an automotive vehicle 10 has a sensor 12 mounted in the front bumper or the grill area 13. The sensor 12 generates a field of view 14. As can be seen, the field of view when positioned forward in the vehicle does not detect a pedestrian 16 positioned to the front of the vehicle.

Referring now to FIG. 1B, vehicle 10 has a sensor 12 mounted within the passenger compartment of the vehicle 10 according to the present invention. In this example, the field of view 14 encompasses the pedestrian 16, which is positioned in the same relative position as FIG. 1A. Thus, by contrasting FIGS. 1A and 1B, one advantage of improving the field of view of the present invention is illustrated. The sensor 12 is located behind windshield 20 in various ways that will be set forth in the embodiments below.

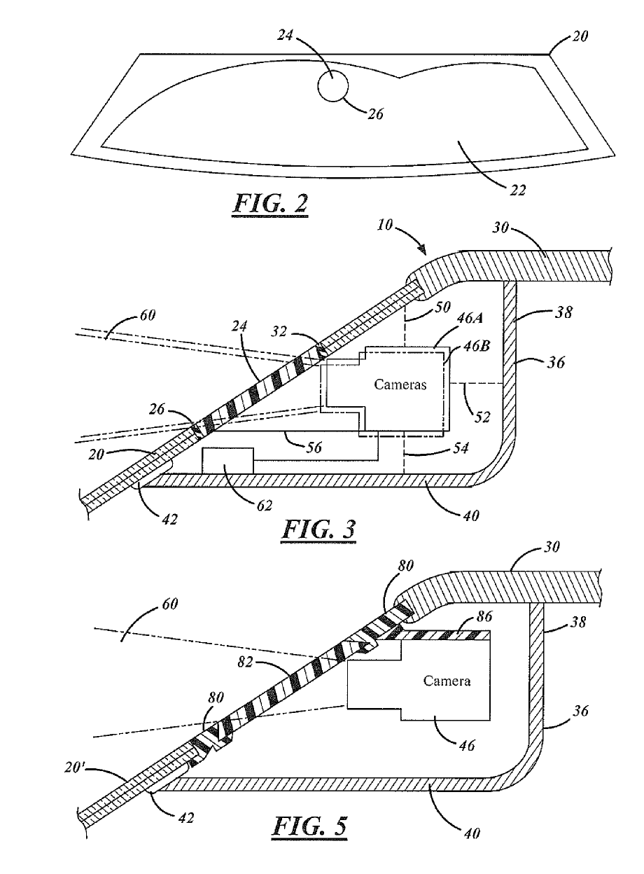

Referring now to FIG. 2, windshield 20 is illustrated in further detail. Windshield 20 has an area 22 that corresponds to the area covered by the windshield wipers. Preferably, the IR transmissive portion 24 is within the area 22 covered by the windshield wipers. In this embodiment, the IR transmissive portion 24 is an insert that is disposed within a hole 26 in the windshield. The hole 26 may be cut or preformed during fabrication of the windshield.

Referring now to FIG. 3, a cross-sectional view of a vehicle 10 shows a simplified view of the roof structure 30 and windshield 20 coupled thereto. The windshield 20 has the opening 26 therein with the IR transmissive window 24 therein. The IR transmissive window 24 may be formed of various IR transmissive materials such as germanium. Of course, those skilled in the art will recognize other materials may be used.

The IR transmissive window 24 is likely to have a different coefficient of thermal expansion (CTE) than the windshield 20. Therefore, a grommet 32 may be disposed between the windshield 20 and the insert 24. Adhesive may be used between the grommet 32 and the windshield 20 and the grommet and the transmissive portion. Preferably, the exterior surface or outside surface of the windshield is flush with the grommet 32 and the IR transmissive insert 24. By providing the grommet and the IR insert flush, wear on the windshield wiper blades is reduced. Also, a potential source for a wind noise is prevented.

A housing 36 which is illustrated as a reverse “L” shaped housing is illustrated. The housing 36 is preferably rigidly mounted to the vehicle roof structure 30. Of course, other mounting schemes coupling the housing 36 to the roof structure may be performed using the headliner (not shown). However, it is believed that providing the housing 36 directly mounted to the roof structure 30 provides a desired amount of rigidity to the system. The housing 36 may be formed of various materials including plastic or metal. Housing 36 may include a vertical portion 38 and a horizontal portion 40. The horizontal portion 40 and the vertical portion 38 may be integrally formed. A gasket 42 may be provided at the end of the horizontal portion 40 to seal the housing 36 to the windshield 20. By providing a tight seal, the interior of the housing 36 may be maintained separately from the interior of the vehicle. This area or the area of the windshield along with the aforementioned inserts may be heated to preclude fogging or the accumulation of ice.

One camera or a pair of cameras 46A and 46B may be disposed within the housing 36 between the housing 36 and the windshield 24. The cameras 46A, 46B may be mounted in various ways with various brackets including being mounted from the windshield using a bracket 50, mounted to the vertical wall 38 using a bracket 52 to the horizontal wall 40 using a bracket 54, or to the IR transmissive insert 24 using a bracket 56. One or various combinations of brackets 50, 56 may be employed to mount cameras 46A, 46B therein. Cameras 46A, 46B form a sensing function to receive infrared, visible or other types of light. One camera 46A may receive near infrared light and the other camera 46B may receive far infrared light. The cameras 46A, 46B have a field of view in the vertical direction 60.

In addition to the cameras 46A, 46B, other electronics 62 may be enclosed within the housing 36. Other electronics 62 may include but are not limited to a controller for the camera 46 or other night vision systems, rain detectors for automatic windshield wipers, occupant sensors or other types of sensors.

One way in which to implement the invention is to cut a hole within the already formed windshield. This may be done by high pressure water jet to cut a hole therein. The high pressure water jet may use sand in a water suspension to cut the glass. The water is under extremely high pressure for which the sand does the actual cutting. A far IR transmissible material such as germanium, chalcogenide glass, polycarbonate or the like may be inserted within the hole. An adhesive may be used to directly bond the IR transmissible material to the windshield directly or preferably with a grommet therebetween. A flexible grommet will allow some coefficient of thermal expansion differences to exist between the windshield and the IR transmissible material.

Preferably, the glass of the windshield and the outer surface of the IR transmissive window are flush to reduce the wear on the windshield wiper blades. However, if the IR transmissive window is not within the windshield wiper area this is not important except for wind noise reduction.

In FIG. 3 the IR transmissive window is shown as being flush on the back surface as well. However, those skilled in the art will recognize that a thinner IR transmissive window may also be used. Likewise, a thicker transmissive window may also be used.

Referring now to FIG. 4A, a second embodiment of the present invention is illustrated with windshield 20′ is generally trapezoidal in shape. The windshield 20′ has a right side 70, a left side 72, a bottom side 74, and a top side 76. In this embodiment, the top side 76 has a notch shape 78 formed therein. The notch shape 78 makes the top side 76 discontinuous. The notch shape 78 may be of various sizes and shapes. An insert 80 may be disposed within the notch 78 to allow the top edge 76 to be continuous. That is, the top edge of the insert 80 and the top edge of the plastic 76 preferably form a continuous shape therein. The insert 80 may be completely formed of IR transmissive material such as those materials described above. However, the plastic insert 80 may also have an IR transmissive window 82 formed therein, while the remaining portions of the insert 80 are not highly IR transmissive.

Referring now to FIG. 4B, a third embodiment is set forth. This embodiment is similar to FIG. 4A in that a trapezoidal insert 80 is used. In this embodiment, a hole is cut in the windshield using the method described above or to mold the windshield with said hole already formed. The insert 80 may be formed of a piece of near IR transmissible material like polycarbonate that may be inserted within the hole 79. This near IR transmissible material would further have a hold 79 cut or molded in it into which a far IR transmissible window would be inserted. In this manner a camera sensitive to near IR would view the scene through the near IR transmissible insert and a camera sensitive to far IR would view the scene through the far IR transmissible window. It should be noted that the portions 80,82 in FIG. 4A may be formed of near and fir IR transmissive materials in the same manner as FIG. 4B.

Referring now to FIG. 5, a cross-sectional view illustrating roof 30 of the automotive vehicle is shown. The housing 36 having vertical side 38 and horizontal sides 40 as well as gasket 42 are the same as those illustrated in FIG. 3 with the variations mentioned above. The camera 46 may be mounted to the plastic insert 80 with a mount 86. The mount 86 may be integrally formed or may be attached to the insert 80 by various means such as adhesive or the like. It should also be noted that instead of mount 86, brackets 50, 52, 54, and 56 described above may also be used to mount the camera 46. The important feature is that the field of view 60 extends through the IR transmissible window 82.

Various ways may be used for mounting the transmissible window 80 to the plastic insert and the plastic insert to the windshield.

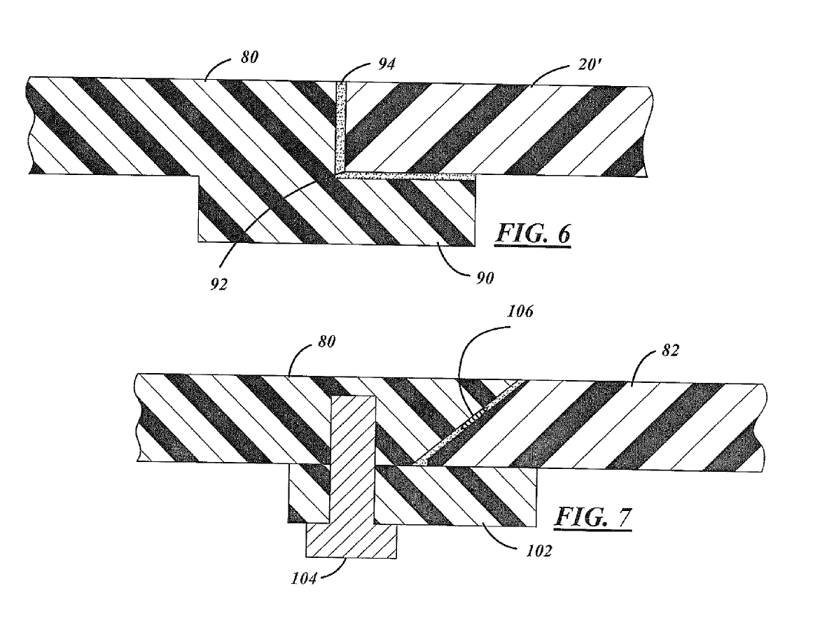

Referring now to FIG. 6, windshield 20′ is illustrated relative to the high impact plastic insert 80. The plastic insert 80 may include a flange 90 thereon. The flange 90 forms a seat 92 between which a bonding or adhesive material 94 may be disposed. It should also be noted that in addition to binding material 94, a grommet or the like may be used therebetween to help compensate for coefficient of thermal expansion differences. The flange 90 is disposed toward the inside of the windshield so that a flush continuous surface is provided on the outside of the windshield 20′. The notch portion 78 of the windshield may be formed by cutting as described above or may be formed without the removal of material in a continuous manufacturing process.

Referring now to FIG. 7, a cross-sectional view of the transmissible window 82 and the plastic insert 80 is illustrated. In this embodiment, a retainer 102 is coupled to the plastic insert 80 by a fastener 104. The transmissible window 82 may be beveled as illustrated or may be straight (90 degrees). Bonding material 106 may be used between the window 82 and the insert 80. An O-ring 106 may also be used between the window 82 and the insert 80 to improve the seat therebetween.

In forming the present invention, a windshield 20′ may be formed having a discontinuous top side, a bottom side, a right side, and a left side. The top side has a notch shape formed therein. As mentioned, the notch shape may be formed during the manufacture of the windshield or may be cut out after the manufacture of the windshield. An insert having an IR transmissive portion is coupled to the top side within said notch so the top side with the insert forms a continuous side.

In forming the present invention, a windshield 20′ may be formed having a top side, a bottom side, a right side, and a left side and a hole in some desired portion of the windshield. As mentioned, the hole may be formed during the manufacture of the windshield or may be cut out after the manufacture of the windshield. An insert having an IR transmissive portion is coupled to the windshield within said hole. The insert may further contain a window transmissible to another portion (for example far IR) of the spectrum.

In the embodiment of FIGS. 4 and 5, the camera may be pre-mounted to the high impact plastic insert so that insertion within the windshield is performed for the complete assembly.

The housing 36 may be positioned with or without preassembly. That is, the housing 36 may be assembled after the windshield is assembled in the vehicle so that the housing 38 may be coupled to the roof structure 30.

While particular embodiments of the invention have been shown and described, numerous variations and alternate embodiments will occur to those skilled in the art. Accordingly, it is intended that the invention be limited only in terms of the appended claims.

What is claimed is:

1. A system comprising:
a windshield with a top side, a bottom side, a right side and a left side, said top side have a notch shape formed therein; and
an insert having an IR transmissive portion is coupled to said top side within said notch so that the topside with the insert forms a continuous side.

2. A system as recited in claim 1 further comprising a grommet disposed between the windshield and the window.

3. A system as recited in claim 1 further comprising a housing rigidly coupled to a vehicle roof structure.

4. A system as recited in claim 1 further comprising a seal disposed between the housing and the windshield.

5. A system as recited in claim 1 further comprising a camera disposed within the housing.

6. A system as recited in claim 1 wherein the camera is coupled to the insert.

7. A system as recited in claim 1 wherein the camera is coupled to the housing.

8. A system as recited in claim 1 wherein the insert is composed of a near IR transmissive material separate from a far IR transmissive portion.

9. A system comprising:
a windshield having a hole therein;
an IR transmissive window disposed within the hole; and
a grommet disposed between the windshield and the window.

10. A system as recited in claim 9 further comprising a housing coupled between the roof and the windshield, the housing coupled to a camera positioned therein, said camera receiving IR through the IR transmissive window.

11. A system as recited in claim 9 wherein the IR transmissive window comprises a near infrared transmissive portion and a far infrared transmissive portion.

12. A system as recited in claim 11 further comprising a first camera receiving near infrared light and second camera is coupled receiving far infrared light.

13. A system as recited in claim 9 further comprising a seal disposed between the housing and the windshield.

14. A method comprising:
coupling an insert having a near IR transmissive portion and a far IR transmissive portion into a notch or hole within a windshield;
receiving a near infrared light in a first camera through the near infrared portion; and receiving far infrared light in a second camera through the far infrared portion.

15. A method as recited in claim 14 further comprising mounting the near infrared camera to the roof and rigidly coupling a housing around the camera to the roof.

16. A method as recited in claim 14 further comprising coupling the camera to the IR transmissive portion.

17. A method as recited in claim 14 wherein the insert of germanium IR transmissive material is composed.

18. A method as recited in claim 14 wherein the near IR transmissive portion is in a windshield wiper path.

19. A method as recited in claim 14 wherein coupling the insert comprises providing a flange on the insert and coupling the flange to the windshield.

20. A method as recited in claim 14 further comprising coupling the insert to the window insert with a retainer coupled to the IR transmissive portion and the insert.
